(19) United States
(12) Patent Application Publication
(10) Pub. No.: US 2015/0298096 A1
(43) Pub. Date: Oct. 22, 2015

(54) BINDER-FREE COMPACT ZEOLITE PREFORMS AND METHOD FOR THE PRODUCTION THEREOF

(71) Applicant: CHEMIEWERK BAD KÖSTRITZ GMBH, Bad Köstritz (DE)

(72) Inventors: Kristin Gleichmann, Gera (DE); Baldur Unger, Leipzig (DE); Alfons Brandt, Gera (DE); Gundula Fischer, Stradtroda (DE); Hannes Richter, Hermsdorf (DE)

(21) Appl. No.: 14/435,948

(22) PCT Filed: Oct. 8, 2013
(86) PCT No.: PCT/EP2013/070957

§ 371 Date: Apr. 15, 2015

(30) Foreign Application Priority Data
Oct. 15, 2012 (DE) 10 2012 020 217.2

(51) Int. Cl. B01J 20/18; B01J 29/08; B01J 20/28; B01J 37/06; B01J 35/04; B01J 37/00; B01J 37/08; B01J 29/70; B01J 20/30

(52) U.S. Cl. CPC B01J 20/18; B01J 29/7003; B01J 29/082; B01J 20/28045; B01J 20/3078; B01J 20/3007; B01J 20/3071; B01J 29/084; B01J 35/04; B01J 37/0009; B01J 37/08; B01J 37/06

(57) ABSTRACT

The present invention relates to compact zeolite preforms, which are characterized in that they have as high a zeolite content as possible determined by means of suitable adsorption methods. A further aspect of the present invention relates to a method for producing compact zeolite preforms, said method being characterized in that: a) a mouldable mixture, comprising zeolite, one or more zeolite precursor components, water (if necessary) and one or more organic additives (if necessary) is processed into preforms; b) the preforms obtained in this way are subjected to thermal treatment; and c) the thermally treated preforms are watered, aged and brought into contact with a further component from which, in combination with the zeolite precursor components, zeolite can be produced and exposed to conditions under which zeolite forms from the further component and the zeolite precursor components. Preforms which can be produced according to this method can advantageously be used for adsorption processes or thermal-chemical applications, for example in energy storage, or as a catalyst, or a component in a catalyst or as a supporting material for zeolite membranes.

### CROSS REFERENCE TO RELATED APPLICATIONS

This application is a national phase of PCT Application Number PCT/EP2013/070957 filed Oct. 8, 2013 which claims priority to German patent application DE102012020217.2 filed October 15, the entire contents of which are hereby incorporated by reference herein.

### BACKGROUND

Zeolites belong to the class of crystalline aluminosilicates to the class and were originally discovered as a natural mineral. The composition of the substance group of zeolites can be described by the following formula (I):

MₙO.Al₂O₃.xSiO₂.yH₂O (I)

wherein the factor n indirectly determines the charge of cation M, which is typically present as an alkali or alkaline earth metal cation. The factor y indicates how many water molecules are present in the crystal. The molar ratio of SiO₂ to Al₂O₃ in the empirical formula is referred to as modulus (x)¹.

### SUMMARY

Commercial interests have mainly obtained synthetic zeolites with a faujasite structure in which two types can be distinguished, depending on their chemical composition. Products with a corresponding framework structure and a modulus of >2, but under 3.0 are referred to as X-zeolites, whereas those with a modulus >3 are referred to as Y-zeolites. Other important zeolites are those with a Linde type A structure. These have a chemical composition matching the zeolite framework, which is characterised by a modulus of 2.

Through the freely selectable cations, the pore size and pore accessibility of the zeolite framework can be influenced and the polar properties of the zeolite type can be changed.

Due to their high chemical and thermal stability, the presence of a regular pore system with pore openings in the sub-nanometre range and the ability to form specific interactions with adsorbed molecules (due, among other things, to a variable cation composition) zeolites are ideal adsorption agents and in a tried and tested way are used both in static, i.e. non-regenerative adsorption processes (for example, the drying of intermediate pane volumes in insulated glass windows²) as well as in dynamic, i.e. regenerative adsorption processes (drying and purification of gases and liquids as well as the separation of substances²). Since the process of adsorption proceeds with the release of heat, the process of regeneration however (desorption) proceeds with heat absorption: It is also possible to use zeolites for heat storage and transition, thus contributing to the conservation of the environment³. After any period of time, the quantity of heat absorbed in the desorption process can practically be released again, almost in full as adsorption heat⁴⁵. With appropriate technology, the described effect can also be used for refrigeration⁶. Furthermore, zeolites are used as a catalyst⁷, catalyst component⁸ or a component for zeolite membranes⁹.

As a rule, since a fluid medium must flow around the adsorption active component in dynamic (regenerative) applications, the corresponding process technique uses so-called absorbers filled with a bed consisting of adsorbent agents. Here, in order to avoid excessive pressure losses across this bulk material, the use of zeolite preforms of a certain minimum size is generally desirable.

The known method for gas or fluid processing¹⁰ that is already used in practice (as well as for catalysis¹¹, heat storage¹² and heat transition) works with a bed that mostly consists of very small bodies, such as zeolite spheroid granules or strands. The volumetric adsorption capacity of such a zeolite bed depends on its bulk density, and this in turn, with equal materials, depends on the filling of space/packing density: The maximum filling of space for spheres with a uniform size is 74% (packed as dense as possible). In order to increase the effectiveness of the relevant processes, greater space filling (more active material per volume) may be desirable. This can theoretically be achieved through the use of mixtures consisting of perfectly matched sphere sizes. However, such optimized mixtures are very expensive to produce and apart from this, higher filling of space usually leads to an undesirable increase in pressure loss (worse flow-through) in the corresponding bed. A honeycomb body represents an alternative. Even at a ratio of 1 (cell connector width to channel diameter) over 80% of space can be filled with hexagonal and triangular honeycomb geometries (Table 1). From a geometrical consideration, at a 3 to 1 ratio of cell connector width to channel diameter, all geometries achieve a space filling index of approx. 95%. At the same time, flow travels through honeycomb bodies easily. As a result of the mutual locking of honeycomb channels, it is possible to create a forced flow through the cell connectors and thus, a further increase in efficiency. By subsequently applying a densely crystallised layer of zeolites, these compact zeolite preforms can also be used for separation on the basis of size or selective adsorption (membrane separation).

TABLE 1
Space filling for a bed of spheres
and different honeycomb geometries.

| | Channel | Cell connector | Space filling |
|---|---|---|---|
| Geometry | size | width | index |
| Sphere packing | — | — | 74% |
| Multi channel tube (round) | 1 | 1 | 72% |
| Square honeycomb | 1 | 1 | 75% |
| Hexagonal honeycomb | 1 | 1 | 82% |
| Triangular honeycomb | 1 | 1 | 85% |
| Multi channel tube (round) | 0.5 | 1.5 | 93% |
| Square honeycomb | 0.5 | 1.5 | 94% |
| Hexagonal honeycomb | 0.5 | 1.5 | 95% |
| Triangular honeycomb | 0.5 | 1.5 | 96% |

In addition, the adsorption capacity of zeolite beds and/or zeolite solid bodies depends on the amount of the adsorption-active zeolite substance.

As zeolite powder (products of classical zeolite synthesis) does not exhibit any binding capacity, adsorption-inert binders are used in practice to produce the corresponding compact preforms^{13,14} or granules¹⁵. The introduction of the binder (as mentioned) causes a ‘dilution’ of the active component and as such, this leads to lower adsorption capacities. Furthermore, the use of an adsorption-inert binder, at least without the use of additional additives as pore formers, leads to the impairment of the actually desired adsorption and desorption processes on the pure zeolite component. This is because often, compression takes place in the process of shaping through structure granulation, extrusion, etc. and at the same time, a pore transportation system is formed which may be unfavourable for the application¹⁵. However, in most cases binder containing zeolite preforms have to be highly porous in order to prevent the mobility of the adsorbing and desorbing molecules as little as possible. Highly porous preforms are obtained for example, by mixing pore formers to the zeolite-binder mixture before the shaping of zeolite preforms containing binder. The added pore formers are burnt out in the final thermal activation of the preform and in doing so, leave a corresponding pore system^{16,17}. There is also the possibility to use water-soluble pore formers¹⁸.

A further possibility of producing zeolite-containing compact preforms is so-called ‘washcoating’. In this case, adsorptive-active and/or catalytically-active powder is applied onto an inert or low active, compact base body (for example honeycomb) as an outer zeolite layer, this also takes place using a non-zeolite binder^{19,20}.

In recent publications, the crystallization of, for example, zeolite ZSM-5 has been described, directly on an aluminium foam²¹. However, this method is relatively complex and gives only provides relatively thin zeolite layers on the aluminium cell connectors.

An improvement to the effect of zeolite beds in the adsorption processes could be achieved by the introduction of so-called binder-free zeolite sphere granules or strands^{18, 22-26}. By forming the very distinct pore transportation system in the granules, the disadvantages of the beds of binder-containing spheroid granules are considerably reduced²⁴. They are characterized by a smallest possible proportion of mesopores (2 nm to 50 nm)²⁷, but as many macropores as possible (>50 nm). The equilibrium adsorption capacities match those of a zeolite powder with an identical chemical composition¹⁵.

The prior art describes classically produced compact preforms based on binders whose binder content leads to a considerable reduction in the adsorptive and/or catalytically active proportion. Through extrusion, these can be produced from a mixture consisting of zeolite, a mixture of twin-layered and triple-layered clay minerals, inorganic fibre materials (e.g. fibreglass²⁸, zirconium dioxide²⁹) and glucans³²⁸. In such products, the equilibrium adsorption capacity is reduced by the amount of adsorption-inert binder used. In addition, the apparent insufficient porosity of the pore transportation system is indicated by the very slow water absorption.

Siloxane compounds are also described as suitable binders for the production of zeolite 3A, 4A, 5A or X-honeycombs³⁰. Apart from the fact that the adsorption-inert binder is also produced from siloxane compounds during processing, the solvent contained in siloxane derivatives (albeit in a small quantity, which can only be removed by applying solvent-specific safety rules) is considered as a disadvantage of this method. The low activation temperature of 280° C. (max.) further described in this method, indicates a power-saving activation process. However, at these temperatures, the required activation state of the finished preform may, if at all, only be achieved within very long activation times. In the present work, ‘activation’ describes a thermal treatment of the zeolite material, wherein the zeolite is displaced in an activation state that is required for the application of the compact zeolite preforms, i.e. one that retains negligible residual moisture content for the application.

The use of pore formers is described in order to improve the pore transportation structure in the production of compact, binder-containing zeolite preforms preforms³¹. A disadvantage here, are the high temperatures required to remove the pore former and solidify the binder (up to 850° C.). In this case, the adsorption capacity is also reduced through the proportion of adsorption-inert binder.

Taking the prior art described above into account, there is therefore a demand for compact zeolite preforms, which do not have the disadvantages of the prior art. In particular, a need exists for compact zeolite preforms which contain no additional binders or solidifier materials and thus contain a very high proportion of zeolite in a defined volume.

Furthermore, there is need for a technical method which is as efficient as possible and which allows for the inexpensive production of mechanically stable, compact zeolite preforms. The compact zeolite preforms that are produced should preferably have a maximum level of active zeolite material, e.g. in the form of zeolites with a faujasite structure (comprising both zeolite X as well as zeolite Y) or the Linde type A structure.

In the present invention, products and methods are described, which satisfy the aforementioned and generally do not have the disadvantages of the prior art.

The present invention relates to compact zeolite preforms, which are characterized in that they have a zeolite content of at least 90%, defined by means of suitable adsorption methods, and preferably at least 95%. Furthermore, the present invention relates to a method for producing compact zeolite preforms, which is characterised in that a) a mouldable mixture, comprising zeolite, one or more zeolite precursor components, water (as necessary) and one or more organic additives (as necessary) is processed into preforms; b) the preforms obtained in this way are subjected to thermal treatment; and c) the thermally treated preforms are watered, aged and brought into contact with a further component from which, in combination with the zeolite precursor components, zeolite can be produced and exposed to conditions under which zeolite forms from the further component and the zeolite precursor components. Another aspect of the present invention relates to compact zeolite preforms which can be produced according to such a method, as well as the use of such compact zeolite preforms for adsorption processes or thermal-chemical applications, e.g. in the storing of energy, as a catalyst, or component of a catalyst or as a supporting material for zeolite membranes. The compact zeolite preforms are characterised by high adsorption capacities that are not affected by an adsorptive inert binder additionally contained in a zeolite preform or other adsorptive inert materials.

When the term ‘water absorption capacity’ is used in the following text, it refers to the specific equilibrium adsorption capacity for water on materials that have been thermally treated at 450° C. over a period of two hours at a temperature of 20° C. and a relative humidity of 55%.

A first aspect of the present invention relates to compact zeolite preforms which are characterized in that they have a zeolite content of at least 90% and preferably at least 95% by means of suitable adsorption methods. For establishing the zeolite content determined in this way, the water adsorption capacities the compact zeolite preforms related to the invention and the initial zeolite powder of the same zeolite structure and same chemical composition were used in proportion to each other. The compact zeolite preforms in accordance with the invention are preferably based on zeolite Y, preferably with a modulus greater than 4.9, and more preferably in the range of 4.9 to 5.5, zeolite X or zeolite A or a mixture of zeolite types.

A compact zeolite preforms, as this term is used in connection with the present invention, is a preform which preferably has a space filling index of 80% or more, particularly preferably 85% or more, and most preferably 90% or more. Within the scope of the present invention, no preform is a preform from which conventional adsorption agents or catalyst beds can be generated (e.g. in the form of spheres or short extruded (as the case may be, hollow) strand preforms). Even spheroid granules that have sizes of sphere that are perfectly matched (as described above) do not fall within the definition of a compact zeolite preform. It is crucial that the compact zeolite preform is used as such, and not in the form of a bed of a variety of bodies, which taken together have the characteristics of a bed.

With regard to the shape, the compact zeolite preform according to the present invention are not subject to any relevant restrictions. The compact zeolite preforms in accordance with the invention can, for example, take the form of a plate, a tube, a solid cylinder or a honeycomb. However, it is preferable that they have a high a space filling index as possible and, at the same time comparatively very good through flow characteristics, for example, as is found in a honeycomb shape with a broad cell connectors and narrow channels.

For the compact zeolite preforms in accordance with this invention, it is preferred that they are substantially free of non-zeolite components.

In the context of the present invention, zeolites with a faujasite or Linde type A structure (or mixtures of both types of zeolites and/or their use in the method described in the following section) are preferred.

If they been produced on the basis of a zeolite with a Linde type A structure, the compact zeolite preforms in accordance with the invention preferably have a water absorption capacity of at least 22 wt. %, and more preferably, at least 24 wt. %. If they have been produced from a zeolite X, they may have a water absorption capacity of at least 27 wt. %. Particularly preferably they have a water absorption capacity of at least 29 wt. % and most preferably they have a water absorption capacity of at least 30 wt. %. If, on the other hand, they have been produced on the basis of zeolite Y, they may have a water absorption capacity of at least 27 wt. %. Particularly preferably they have a water absorption capacity of at least 28 wt. % and most preferably they have a water absorption capacity of at least 29 wt. %.

Another aspect of the present invention relates to a method for producing compact of zeolite preforms, characterized in that a) a mouldable mixture, comprising zeolite, one or more zeolite precursor components, water (as necessary) and one or more organic additives (as necessary) is processed into preforms; b) the preforms obtained in this way are subjected to a thermal treatment; and c) the thermally treated preforms are watered, aged and brought into contact with a further component from which, in combination with the zeolite precursor components, zeolite can be produced and exposed to conditions under which zeolite forms from the further component and the zeolite precursor components.

In this method powdered zeolite is preferably used as a raw material which, as a consequence of its structural composition, is not plasticizable in its pure form is and thus does not represent a preferable raw material for plastic forming processes. This zeolite is mixed with one or more zeolite precursor components. The main is zeolite precursor components are preferably clay minerals with the chemical composition Al₂Si₂H₄0₉ such as kaolinite or halloysite. Other zeolite precursor components can be, for example, sodium hydroxide or sodium silicate. As the zeolite precursor components are supposed to be converted to zeolite in the novel process, they may essentially consist of chemical elements/compounds contained in the corresponding zeolite.

According to the prior art, it is very difficult to use kaolin containing kaolinite as a main component as a binder e.g. for the mixtures intended for the extrusion. This is because, under certain circumstances, these mixtures are much more difficult to plasticize than other systems.

In order to improve the plasticity of the mass to be deformed, water and/or an organic components (with a temporary binder effect and/or lubricant) can be added in appropriate amounts as additives initial mixture consisting of zeolite and zeolite precursor components.

Within the context of step a), the resulting mass is then processed by an appropriate method to form preforms i.e. formed into the desired shape. Extrusion, pressing or casting can be used as a preferable method.

In a particularly preferred embodiment, preforms are processed through extrusion. In the extrusion process the known units from the prior be used. The plastic mixture produced in a twin shaft mixer is preferably extruded with a vacuum screw extruder to form continuous strands, wherein the strands are subsequently shortened to form a manageable length and are then preferably dried with 5 to 20% loss on drying, or particularly preferably, with 5 to 10% loss on drying. Loss on drying refers to the quantity of water which the tested sample loses within an hour when treated at 105° C.

In a further particularly preferred embodiment, preforms are processed by pressing a mixture of zeolite, zeolite precursor components and/or water and/or one or more organic additives, preferably a polyvinyl alcohol solution.

When processed by pressing, it is also preferable that granules are initially produced from a kaolin-zeolite-mixture, preferably by means of a thermal granulation process in accordance with the prior art, and more preferably by means of a mechanical granulation process in accordance with the prior art by adding a solution consisting of one or more organic components having temporary binder effect. This may take place in a mixer which contains the kaolin-zeolite mixture. After homogenising, the granules obtained in this way are dried and pressed on a dry press to form preforms.

In a another particularly preferred embodiment, the processing to form preforms is carried out by casting a zeolite-kaolin-water mixture (as necessary, with the addition of further components) into a dry gypsum mould.

When processing by casting, it is preferable that the kaolin-zeolite mixture is processed with deionized water and a dispersant (preferably bi-functional Carboxylic acids) in a grinding drum with the aid of grinding balls to form a homogeneous, pourable slurry. The slurry produced in this way is poured into a porous mould. The mould removes the water from the zeolite-kaolin-water mixture resulting in a so-called shard which is removed from this mould after an appropriate holding time and then dried.

In a method according to the invention, a type 4A or X or Y dried zeolite powder is preferably used as an initial material. This preferably uses a modulus greater than 4.9, and more preferably in the range of greater than 4.9 to 5.5. The zeolite powder that is described can be used as a filter cake or as a slurry, wherein the corresponding moisture content must be taken into account in the processing of the mass to be deformed.

It may be desirable that the main zeolite precursor components do not exceed a proportion of non-convertible zeolite components, e.g. 5 wt. % mica or quartz, and preferably 1 wt. %.

In the mouldable mixture in step a) of the described process, the zeolite and the zeolite precursor components are preferably used in a weight ratio of 10:1 to 1:10, more preferably 1:1 to 6:1. If necessary, an additional organic components with a temporary binder effect and/or lubricants and/or water may be incorporated into the mixture.

In step b) of the process described above, the preforms obtained from step a) are subjected to thermal treatment. In so doing, it is preferred if the preforms are heated to a temperature of 550° C. to 850° C., preferably 550° C. to 650° C. For this thermal treatment, it may be advantageous if the preforms are initially dried before the thermal treatment, preferably at a dry loss of 5-10%. During the thermal treatment, the organic component that may remain is removed, the zeolite precursor components are subjected to a structural conversion and the main casting is solidified. Subsequently, the resulting preforms are cooled down, free of cracks.

At this point in the technology chain, the preforms can, if necessary, be cut to the desired shape.

Before the heat-treated preforms are brought into contact with another component, they are preferably subjected a wash in step c). For this, the heat-treated preforms are treated with water or a diluted sodium hydroxide solution (a NaOH solution between 0.5% and 5%, preferably between 1% and 2%).

In the case of the further component which is likewise brought into contact with the thermally treated preforms during step c), these is a component which, as necessary, in terms of its nature or quantity, contains chemical elements or compounds that lack the zeolite precursor components compared to the zeolite to be produced in step c). Preferably, the further component is an alkali silicate solution or alkali aluminate solution, and more preferably a sodium silicate solution or a sodium aluminate solution. It is further preferable that, an alkali silicate solution is used as an additional component if, in the course of step c) zeolite is to be formed with a faujasite structure. In the case of the intended production of zeolite with a Linde type A structure in step c), it is preferable if an alkali metal aluminate solution is used as a further component.

The heat-treated preform is preferably brought into contact with the further component in step c) at a temperature ranging from 75° C. to 100° C. and particularly preferably, at a temperature ranging from 80° C. to 95° C. In this step, it is further preferable that the additional component is brought into contact with the zeolite precursor components over a period of 1 to 48 hours, and preferably 8 to 24 hours. In a particularly preferred embodiment, in addition to the temperature treatment described above, the process of bringing the further component into contact with the zeolite precursor components comprises aging that that takes place prior to this temperature treatment. This takes place at a temperature of 15° C. to 60° C., preferably 20° C. to 35° C., over a period of 0.5 h to 24 h, preferably 1 h to 5 h. It may be irrelevant whether a solution of the other component is used for the aging and heat treatment, or whether an initial solution of the other component is used for the aging while a second solution is used for the temperature treatment. With regard to its composition, the second solution may be the same or different from the initial solution.

Furthermore after washing is carried out (as necessary) and/or aging is carried out (as necessary) and the treatment is carried out at 80° C. to 95° C., it is preferable if the product obtained from the method described in the previous sections is brought into contact with one or more washing solutions. These washing solutions are preferably water, more preferably deionized water and/or sodium hydroxide solutions, the latter being preferably at a concentration of 0.01 to 10%, and most preferably at a concentration of 0.5 to 5%. After washing with the washing solution, the product can additionally be washed with water, preferably deionized water, then dried and subsequently activated.

In a particularly preferred embodiment, the compact zeolite preforms in accordance with the invention are treated as follows within the scope of step c):

The compact preforms obtained in step b), are first subjected to a “wash”. For this, rinse water or a diluted sodium hydroxide solution (the solution contains between 0.5% and 5%, preferably between 1 and 2% NaOH) continuously flows through the material in an agitator vessel or in a column filled with compact preforms. The weight ratio of demineralized water or sodium hydroxide to compact (rough) preforms is 5:1 to 50:1, and preferably between 8:1 and 18:1. The washing is carried out at a temperature between 15° C. and 40° C., and preferably at room temperature. The washing process is completed within 3 mins. to 120 mins, and preferably 15 mins to 60 mins. The compact, washed preforms are preferably aged in an aqueous reaction consisting of sodium silicate and sodium hydroxide in the case of the conversion of non-zeolite material into a zeolite with a faujasite structure and an aqueous reaction consisting of sodium aluminate and sodium hydroxide in the case of the conversion of non-zeolite components into a zeolite with a Linde type A structure, i.e. the material is left in the respective solution at 15° C. to 60° C., preferably between 20° C. and 35° C. for 0.5 h to 24 h, preferably 0.5 h to 5 h. The subsequent conversion of the non-zeolite components into zeolite can be carried out in a suitable vessel, preferably an agitator vessel or (additionally flowed through in a continuous concentration that was similar to the reaction solution or the same solution as was used for aging) using the column filled with compact preforms. At the same time, the weight ratio of the reaction solution to the compact preforms is between 5:1 to 50:1, and preferably 8:1 to 18:1. The reaction temperature should be selected between 75° C. and 100° C., and preferably between 80° C. and 95° C. The time until reaching compact preforms consisting entirely of zeolite is between 8 h and 48 h. After the end of the reaction time, the compact zeolite preforms are washed with deionized water for so long, until the pH value is below 12. As a result of a preliminary washing step with a diluted solution of sodium hydroxide with a concentration of between 0.01% and 10%, and preferably between 0.5 and 5% NaOH, the amount of washing water can be reduced.

The spent reaction solution from the conversion step can be recycled and used again for a subsequent treatment step with new compact preforms.

A further aspect of the present invention relates to compact preforms consisting entirely of zeolite, known as compact zeolite preforms in the following, which are obtainable in accordance with a method as described above. These compact zeolite preforms preferably have a zeolite content of at least 90% and preferably at least 95%, as determined by means of suitable adsorption methods.

The compact zeolite preforms according to the invention are preferably made of zeolite Y, preferably with a modulus greater than 4.9, and more preferably, in a range greater than 4.9 to 5.5, or zeolite X or zeolite A.

The compact zeolite preforms produced by this method can for example, take the form of a honeycomb structure, a single or multi-channel tube, a plate, or a solid cylinder.

Surprisingly, in connection with the extrusion, the technology chain described above starting from zeolite and zeolite precursor components (which do not represent optimal starting materials for extrusion) has established that zeolite preforms that are sufficiently mechanically stable, crack-free, compact and binder-free can be produced via the solidification as well as the conversion of zeolite precursor components into zeolite for the applications mentioned above, wherein the disadvantages of known products described in the prior art are not observed.

Surprisingly, it has further been found that mechanically stable, crack-free, compact and binder-free zeolite preforms can be obtained with the aid of the pressing and casting shaping methods in the technology chain, after converting the used zeolite precursor into zeolite.

Another aspect of the present invention relates to the use of the compact zeolite preforms described above as adsorbent agents, e.g. for processing gas in technical adsorption processes. Further preferred applications of the preforms in accordance with the invention relate to methods for thermal-chemical energy storage, such as heat pumps or for generating cold temperatures, as a catalyst or catalyst component or as a carrier for zeolite membranes.

An x-ray graph of the compact zeolite preforms in accordance with the invention indicate a zeolite fraction of between 86 and 100%. As the equilibrium adsorption capacities are only slightly below those of the initial zeolite powder that is used, it can be assumed that the compact zeolite preforms consist of approx. 100% zeolite, but as has already described in²³, part of this zeolite is not detectable by X-ray. Obviously similar phenomena occur in both methods, despite different production methods.

Through the production method that has been explained, the goal of producing compact zeolite preforms that have a high space filling index using active zeolite material has been achieved. The various ceramic moulding technologies shape the production process flexibly, so that it is possible to produce the exact preform geometry that seems to be most advantageous for the later application.

### BRIEF DESCRIPTION OF THE DRAWINGS

FIG. 1 shows diffraction patterns of a zeolite 4A powder (broken line, initial material 1) and a produced compact zeolite preforms.

FIG. 2 shows diffraction patterns of a zeolite X powder and a zeolite 7 channel tube which is produced with a faujasite structure and a zeolite X composition.

FIG. 3 shows diffraction patterns of zeolite Y powder and a zeolite 1 channel tube which is produced with a faujasite structure and a zeolite Y composition.

### DETAILED DESCRIPTION

The following examples aim to illustrate the principles of the present invention in greater detail, however they do not restrict the scope of protection in any way.

### Initial Material 1: Zeolite 4A

For the examples described here, zeolite 4A (Zeolon, MAL AG) with the following properties has been used for the production of compact binder-free zeolite 4A preforms:

| | |
|---|---|
| Water absorption capacity | 24.8% |
| d₅₀ (average particle diameter) | 3.7 μm |
| Loss on ignition | 20.0% |

Particle diameter: “Mastersizer 2000” and dispersing instrument “Hydro 2000 S” from Malvern Instruments
Loss on ignition: Loss of mass after 1 h at 950° C.

### Initial Material 2: Zeolite X

For the examples described here, zeolite X (KÖSTROLITH® NaMSX, Chemiewerk Bad Köstritz GmbH) with the following properties has been used for the production of compact binder-free zeolite X preforms:

| | |
|---|---|
| Modulus (RFA) | 2.34 |
| Water absorption capacity | 30.8% |
| d₅₀ | 3.6 μm |
| Loss on ignition | 21.1% |

Module: X-ray fluorescence spectrometer “S4 EXPLORER” from Bruker-AXS GmbH, Karlsruhe, software package “SPECplus”

### Initial Material 3: Zeolite Y

For the examples described here, zeolite Y (CBV100, Zeolyst International) with the following properties has been used for the production of compact binder-free zeolite Y preforms:

| | |
|---|---|
| Modulus (RFA) | 5.3 |
| Water absorption capacity | 29.1% |
| d₅₀ | 4.5 μm |
| Loss on ignition | 25.2% |

### Initial Material 3: Kaolin

The commercially available Kaolin KF-2 that was used (Prosco Ressources) has the following properties:

| | |
|---|---|
| Si0₂/wt. % | 53.1 |
| Al₂0₃/wt. % | 44.1 |
| Quartz content/% | 2 |

SiQ₂, Al₂O₃ content: X-ray fluorescence spectrometer “S4 EXPLORER” from Bruker-AXS GmbH, Karlsruhe, software package “SPECplus”

Quartz content: X-ray powder diffractometer (XRD) “D4 ENDEAVOR” from Bruker-AXS GmbH, Karlsruhe, software package “DIFFRACplus”

Conventional Honeycombs Containing Binder from Zeolite Type 4A

For comparison, a continuous honeycomb strand is produced by extrusion with a vacuum screw extruder from a plastic mass produced in a twin shaft mixer consisting of 78 wt. % zeolite 4A, 18 wt. % bentonite (Cerartosil; inorganic binder), 2 wt. % organic component with a temporary binder effect (Tylose CER 40600) and 2 wt. % glycerol and water. For the subsequent drying, the strand is cut into 300 mm long honeycomb pieces and dried at 60° C. After drying, the honeycombs are cut into pieces (9 cm long) and subsequently thermal treated at 600° C. In this temperature treatment, the organic matter and water are removed and the structure of the honeycomb is solidified by the inorganic binder.

Comparison Material 1: Zeolite 3A Powder

The commercially available zeolite 3A powder (Luoyang Jianlong Chemical Industrial Co., LTD.) has the following properties:

| Ion exchange level/% | Water adsorption capacity/% |
|---|---|
| 58 | 25.7 |

Ion exchange level: X-ray fluorescence spectrometer “S4 EXPLORER” from Bruker-AXS GmbH, Karlsruhe, software package “SPECplus”

Comparison Material 2: (Zeolite 5A Powder)

The Zeolite 5A powder (Chemiewerk Bad Köstritz GmbH) has the following properties:

| Ion exchange level/% | Water adsorption capacity/% |
|---|---|
| 74 | 22.8 |

All of the analytical tests carried out showed that the preforms are homogeneous, both after the conversion of the zeolite precursor component into zeolite and after the ion exchange.

### Example 1

Starting with 2250 g of zeolite 4A powder (initial material 1) and 990 g of kaolin (initial material 4) a plastic mass is produced in a twin shaft mixer using 5 wt. % of the organic component with a temporary binder effect MHPC 20000, 2% glycerol and water. The plasticized mass is shaped in a vacuum screw extruder. At the same time, the mass is deaerated in the vacuum chamber of the extruder and by means of a pressing screw, it is pressed through a shaping die to form a honeycomb shape. The honeycomb that is formed emerges as a compact continuous preform. After extrusion, it is cut to a length of 100 mm suitable for the subsequent technological steps, dried with a 5% loss on drying and then annealed at 550° C. on firing auxiliaries.

Using diamond separation blades, the compact, tempered honeycombs are cut dry to 9 cm in length.

After tempering, the non-zeolite components of the honeycomb are converted into zeolite with the Linde type A structure. For this, honeycombs with a total weight of 50 g are rinsed with 300 ml of deionized water, i.e. left in water for 30 mins. After the predetermined time, the water is poured off as much as possible and replaced with the reaction solution. This consists of 500 ml of deionized water, 38 g of a 50% sodium hydroxide solution and 8.5 g of sodium aluminate (20% Na₂O, 20% Al₂O₃). The honeycombs are aged in this solution for 1 h at room temperature and then heated to 85° C. and kept at this temperature for 16 h.

After the reaction time, the material is cooled, and the supernatant solution is removed by decantation. The honeycombs are washed three times with 200 ml of deionized water and filtered as dry as possible using a vacuum via a Buchner funnel. They are then dried completely under an IR lamp and finally activated at 450° C. within 2 h.

The material produced in this way indicates a crystallinity of 92% (XRD) based on the initial zeolite powder and a static water absorption capacity of 24.7%. The zeolite content determined by the water adsorption is 99.6%.

The material produced in this way has a residual moisture content of 0.8 (mass) % (determined by Karl Fischer titration (700° C.)).

The following table shows a comparison between the initial zeolite powder, the clay bonded zeolite honeycombs and the binder-free zeolite honeycombs with a Linde type A structure.

TABLE 2
C Zeolite 4A powder, clay bonded and binder-free zeolite 4A.

| | Zeolite | Clay-bonded zeolite | Binder-free |
|---|---|---|---|
| | 4A powder | 4A honeycomb | honeycomb |
| | (initial | (conventional | (zeolite 4A, |
| | material 1) | compact preform) | example 1) |
| Crystallinity (water | 100 | 79.8 | 99.6 |
| adsorption capacity; | | | |
| based on the zeolite | | | |
| 4A initial powder)/% | | | |
| Crystallinity (XRD | 100 | 78 | 92 |
| based on the zeolite | | | |
| 4A initial powder)/% | | | |
| Modulus | 2.00 | — | 2.00 |
| Water adsorption | 24.8 | 19.8 | 24.7 |
| capacity/mass % | | | |
| Average pore diameter | — | 0.30 | 0.48 |
| of the Pore transporta- | | | |
| tion system - μm | | | |
| Static CO₂ adsorption | | | |
| capacity at 25° C./ | | | |
| cm³/g | | | |
| at 1.8 Torr | 31.3 | 19.2 | 30.1 |
| at 34 Torr | 66.4 | 47.5 | 65.6 |
| at 250 Torr | 84.7 | 63.0 | 82.2 |
| Static N2 adsorption | 8.4 | 6.5 | 8.9 |
| capacity at 30° C., | | | |
| 750 mbar/cm³/g | | | |

Crystallinity (XRD): X-ray powder diffractometer (XRD) “D4 ENDEAVOR” from Bruker-AXS GmbH, Karlsruhe, software package “DIFFRACplus”

Water adsorption capacity: The material is activated for 2 h at 450° C. and charged with water at 55% relative humidity and 25° C. until equilibrium is reached.

Average pore diameter: Hg porosimeter PASCAL P140, -P440 from Porotec.
Static CO₂ and N₂ adsorption capacity: The material is activated for 2 h under 0.01 mbar at 400° C. The measurement takes place at 25° C. on a sorption “GEMINI” instrument from Micromeritics.

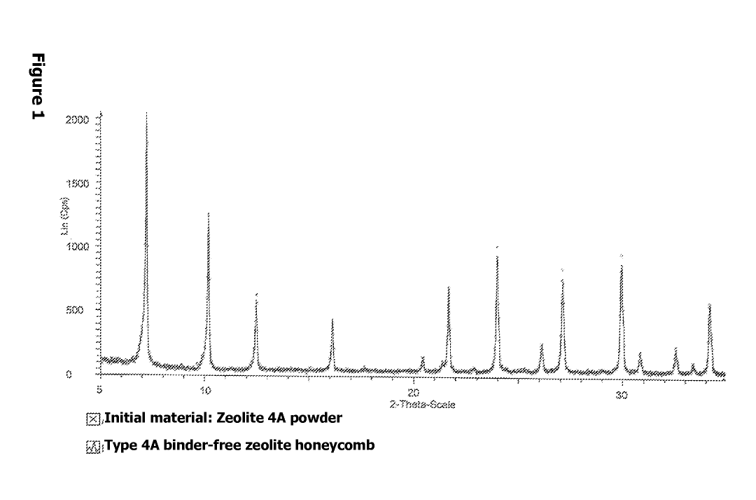

FIG. 1 shows the diffraction patterns of zeolite 4A powder (broken line, initial material 1) and the produced compact zeolite preforms (solid line, example 1) are shown. These are nearly identical.

### Example 2

48 g of the type 4A binder-free zeolite honeycombs in accordance with example 1 (in accordance with the invention) are stored in water for 1 h at room temperature and then for 48 h at room temperature in a 5% solution of potassium chloride (1 litre). Occasionally, the supernatant solution is rotated. Subsequently, the solution is decanted and the honeycombs are washed and dried. The resulting compact zeolite preforms 3A exhibit the following features:

| | Comparison material 1 | Binder-free honeycomb |
|---|---|---|
| | (zeolite 3A powder) | (zeolite 3A, example 2) |
| Ion exchange level/% | 58 | 63.5 |
| Water adsorption | 25.7 | 22.6 |
| capacity/% | | |

### Example 3

48 g of the type 4A binder-free zeolite honeycombs in accordance with example 1 (in accordance with the invention) are stored in water for 1 h at room temperature and then for 48 h at room temperature in a 5% solution of calcium chloride (1 litre). Occasionally, the supernatant solution is rotated. Subsequently, the solution is decanted and the honeycombs are washed and dried. The resulting compact zeolite preforms 5A exhibit the following features:

| | Comparison material 1 | Binder-free honeycomb |
|---|---|---|
| | (zeolite 5A powder) | (zeolite 5A, example 3) |
| Ion exchange level/% | 74 | 76 |
| Water adsorption | 22.8 | 22.7 |
| capacity/% | | |

### Example 4

Starting from 1.7 kg of zeolite X powder (initial material 2), 850 g of kaolin (initial material 4) and 25 g of a sodium hydroxide solution (50%) a plastic mass is produced in a twin-shaft mixer using 5% of the organic component with a temporary binder effect MHPC 20000, 2% glycerol, lubricant and water. The shaping of the plasticized mass takes place in a vacuum screw extruder. The mass is vented in the vacuum chamber of the extruder and by means of a press screw, it is pressed through a 7 channel forming tube tool. The 7 channel tube is formed as a compact continuous preform. After extrusion, it is cut to a length of 500 mm suitable for the subsequent technological steps, dried with a 5% loss on drying and then annealed at 550° C. on firing auxiliaries:

Using diamond separation blades, the annealed 7-channel tubes are cut dry to 100 mm in length.

After tempering, the non-zeolite components of the 7-channel tubes are converted into zeolite with a faujasite structure. For this, 7-channel tubes with a total weight of 30 g are watered with 200 ml of deionized water, i.e. left in water for 60 mins. After the predetermined time, the water is largely decanted and replaced by and the reaction solution. This consists of 240 ml of deionized water, 54 g of a 50% sodium hydroxide solution and 15 g of sodium silicate (8% Na₂O, 27% SiO₂). The watered 7-channel tubes are aged in this solution for 2 hours at room temperature, then heated to 85° C. and kept at this temperature for 16 h.

After the reaction time the material is cooled down and the supernatant solution is removed by decantation. The 7-channel tubes are washed three times with 200 ml of deionized water, filtered as dry as possible using a vacuum via a Buchner funnel and then dried completely under an IR lamp.

The material produced in this manner exhibits a crystallinity of 90% (XRD) based on the initial zeolite powder and a static water absorption capacity of 29.2%. The zeolite content determined by the water adsorption is 94.8%.

The following table shows a comparison between the initial zeolite powder and the compact binder-free zeolite preforms with a faujasite structure.

TABLE 3
Comparison between zeolite powder and binder-free
zeolite 7 channel tubes with a faujasite structure

| | Zeolite | Binder-free compact |
|---|---|---|
| | X powder | preforms of the faujasite |
| | (initial | structure and zeolite X |
| | material 2) | composition (example 4) |
| Crystallinity (water adsorption | 100 | 94.8 |
| capacity; based on the zeolite | | |
| 4A initial powder)/% | | |
| Crystallinity (XRD based on | 100 | 90 |
| the zeolite X initial powder)/% | | |
| Modulus | 2.34 | 2.35 |
| Water adsorption capacity/mass % | 30.8 | 29.2 |
| Average pore diameter of the | — | 0.89 |
| pore transportation system/μm | | |
| Static CO₂ adsorption | | |
| capacity at 25° C./cm³/g | | |
| at 1.8 Torr | 35.0 | 28.9 |
| at 34 Torr | 81.7 | 74.8 |
| at 250 Torr | 120.7 | 112.1 |
| Static N₂ adsorption | 10.7 | 9.8 |
| capacity at 30° C., | | |
| 750 mbar/cm³/g | | |
| Micropore volumes/cm³ g | 0.33 | 0.31 |

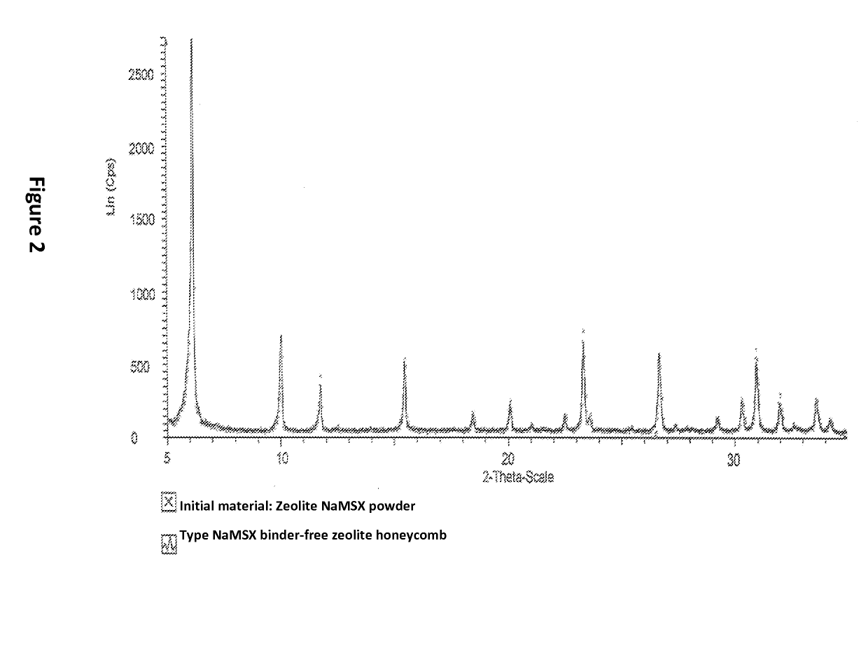

FIG. 2 shows the diffraction patterns of zeolite X powder (dotted line, initial material 2) and the zeolite 7 channel tube which is produced with a faujasite structure and a zeolite X composition (solid line, example 4). These are nearly identical.

### Example 5

Starting from 2.5 kg of zeolite X powder (initial material 3), 850 g of kaolin (initial material 4) and 80 g of sodium hydroxide solution (50%) a plastic mass is produced in a twin-shaft mixer using 5% of the organic component with a temporary binder effect MHPC 20000, 2% glycerol, lubricant and water. The shaping of the plasticized mass takes place in a vacuum screw extruder. The mass is vented in the vacuum chamber of the extruder and by means of a press screw, it is pressed through a 1 channel forming tube tool. The 1 channel tube is formed as a continuous strand. After extrusion, it is cut to a length of 500 mm suitable for the subsequent technological steps, dried with a 5% loss on drying and then annealed at 550° C. on firing auxiliaries:

Using diamond separation blades, the annealed 1 channel tubes are cut dry to 200 mm in length.

After tempering, the non-zeolite components of the 1 channel tubes are converted into zeolite with a faujasite structure. For this, 1 channel tubes with a total weight of 30 g are watered with 200 ml of sodium hydroxide solution (1%), i.e. left in a sodium hydroxide solution (1%) for 60 mins. After the predetermined time, the sodium hydroxide solution is largely decanted and replaced by and the reaction solution. This consists of 190 ml of deionized water, 8 g of a 50% sodium hydroxide solution and 60 g of sodium silicate (8% Na₂O, 27% SiO₂). The watered 1 channel tubes are aged in this solution for 2 hours at room temperature, then heated to 90° C. and kept at this temperature for 20 h.

After the reaction time, the material is cooled, and the supernatant solution is removed by decantation. The 1 channel tubes are washed three times with 150 ml of a sodium hydroxide solution (1%) and filtered as dry as possible using a vacuum via a Buchner funnel. They are then dried completely under an IR lamp.

The material produced in this manner exhibits a crystallinity of 96% (XRD) based on the initial zeolite powder and a static water absorption capacity of 28%. The zeolite content determined by the water adsorption is 96.2%.

The following table shows a comparison between the initial zeolite powder and the binder-free 1 channel tubes with a faujasite structure and zeolite Y composition.

TABLE 4
Comparison between zeolite powder and binder-free zeolite 1 channel
tubes with a faujasite structure. and zeolite Y composition

| | Zeolite Y | Binder-free compact |
|---|---|---|
| | powder - | preforms of the faujasite |
| | (initial | structure and zeolite Y |
| | material 3) | composition (example 5) |
| Crystallinity (water adsorption | 100 | 96.2 |
| capacity; based on the zeolite | | |
| Y initial powder)/% | | |
| Crystallinity (XRD based on | 100 | 96 |
| the zeolite Y initial powder)/% | | |
| Modulus | 5.3 | 5.3 |
| Water adsorption capacity/mass % | 29.1 | 28.0 |
| Average pore diameter of the | — | 0.30 |
| pore transportation system/μm | | |
| Static CO₂ adsorption | | |
| capacity at 25° C./cm³/g | | |
| at 1.8 Torr | 3.9 | 4.4 |
| at 34 Torr | 32.2 | 31.4 |
| at 250 Torr | 94.8 | 90.8 |
| Static N₂ adsorption | 5.5 | 5.4 |
| capacity at 30° C., | | |
| 750 mbar/cm³/g | | |
| Micropore volumes/cm³ g | 0.33 | 0.32 |

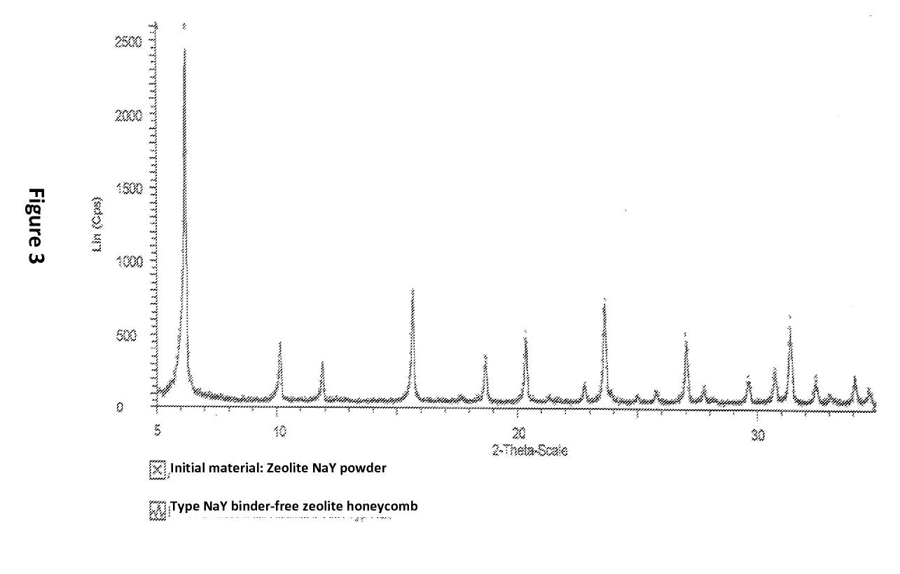

FIG. 3 shows the diffraction patterns of zeolite Y powder (dotted line, initial material 3) and the zeolite 1 channel tube which is produced with a faujasite structure and a zeolite Y composition (solid line, example 5). These are nearly identical.

### Example 6

The production of 1 channel tubes takes place in the same way as example 5.

After tempering, the non-zeolite components of the 1 channel tubes are converted into zeolite with a faujasite structure. For this, 1 channel tubes with a total weight of 30 g are moved with a reaction solution consisting of 190 ml deionized water, 8 g of a 50% sodium hydroxide solution and 60 g of sodium silicate (8% Na₂O, 27% SiO₂) and then heated to 90° C. and kept at this temperature for 20 h.

After the reaction time, the material is cooled, and the supernatant solution is removed by decantation. The 1 channel tubes are washed three times, each time with 200 ml of deionized watered and filtered as dry as possible using a vacuum via a Buchner funnel. They are then dried completely under an IR lamp.

The material produced in this manner exhibits a crystallinity of 81% (XRD) based on the initial zeolite powder, a modulus of 5.3% and a static water absorption capacity of 26.9%. The zeolite content determined by the water adsorption is 92.4%.

### Example 7

The production of 1 channel tubes takes place in the same way as example 5.

After tempering, the non-zeolite components are converted into zeolite with a faujasite structure. For this, 1 channel tubes with a total weight of 30 g are moved with a solution consisting of 190 ml deionized water, 8 g of a 50% sodium hydroxide solution and 60 g of sodium silicate (8% Na₂O, 27% SiO₂) and the mixture is aged for 2 h at room temperature. Then, they are heated to 90° C. and kept at this temperature for 20 h.

After the reaction time, the material is cooled, and the supernatant solution is removed by decantation. The 1 channel tubes are washed three times, each time with 200 ml of deionized watered and filtered as dry as possible using a vacuum via a Buchner funnel. They are then dried completely under an IR lamp.

The material produced in this manner exhibits a crystallinity of 84% (XRD) based on the initial zeolite powder, a modulus of 5.3% and a static water absorption capacity of 27.5%. The zeolite content determined by the water adsorption is 94.5%.

### Example 8

A moist mixture is produced in a mixer at 1000 rev./min from zeolite with a Linde type A structure (initial material 1), kaolin (initial material 4) and a sodium hydroxide solution at 30 parts kaolin (by mass) (dry) to 70 parts 4A zeolite (by mass) (dry) to 3.5 parts of a 50% NaOH solution (by mass). 2% (10%) Mowiol binder solution is added in drops. The mixture is stored in a covered state for 24 hours in order to homogenize the humidity. The mixture is then ground through a sieve with a mesh width of 1 mm and the sieve granules obtained in this way are dried with a 6% loss on drying. After drying, the granules are pre-pressed on a dry press with a press pressure of 600 MPa to the cylinders with a diameter of 18 mm and a thickness of 10 mm. By grinding the compacts through a 1 mm sieve, it is possible to obtain pressable granules. From these granules, preforms with a diameter of 60 mm and a thickness of 3 mm are then produced on the dry press with a specific pressure of 1000 MPa. Annealing of these discs takes place when they are placed on firing plates made from engobed silicon carbide at 500° C.

After tempering, the non-zeolite components of the preforms are converted into zeolite with Linde type A structure in the same way as in example 1.

TABLE 5
Properties of the binder-free zeolite 4A discs.

| | Zeolite 4A | Binder-free disc |
|---|---|---|
| | powder (initial | (zeolite 4A, |
| | material 1) | example 8) |
| Crystallinity (XRD based on the | 100 | 92 |
| zeolite 4A initial powder)/% | | |
| Crystallinity (water adsorption | 100 | 98.8 |
| capacity based on the zeolite | | |
| 4A initial powder)/% | | |
| Modulus | 2.00 | 2.01 |
| Water adsorption capacity/Mass % | 24.8 | 24.5 |
| Average pore diameter of the | — | 0.71 |
| pore transportation system/μm | | |

### Example 9

In a 10 l grinding drum, 4 kg grinding balls (20 mm) are initially weighed. 4 kg of raw material mixture is them added consisting of 70 parts (by mass) of zeolite 4A powder (dry) and 30 parts (by mass) of kaolin (dry). After adding 4 l deionized water and 0.3% dispersant (Dolapix CE64) the grinding drum is closed and the slip is ground to a grinding frame for 24 h. After the grinding process, the slip is poured through a 0.1 mm sieve. The casting of the slip is carried out as a plate measuring 100×100×12 mm³ in dry plaster cast. After standing for approx. 75 minutes (depending on shard formation, which in turn affected by the ambient temperature and humidity) the plate is removed from the mould and dried with drying loss of 5%). Annealing of these plates takes place when they are placed on firing plates made from engobed silicon carbide at 500° C.

After tempering, the non-zeolite components of the preforms are converted into zeolite with Linde type A structure in the same way as in example 1.

TABLE 6
Properties of the binder-free zeolite 4A plate.

| | Zeolite 4A | Binder-free disc |
|---|---|---|
| | powder (initial | (zeolite 4A, |
| | material 1) | example 8) |
| Crystallinity (XRD based on | 100 | 92 |
| the zeolite A initial powder)/% | | |
| Crystallinity (water adsorption | 100 | 98.8 |
| capacity based on the zeolite | | |
| 4A initial powder)/% | | |
| Modulus | 2.00 | 20.01 |
| Water adsorption capacity/Mass % | 24.8 | 24.5 |

### LITERATURE

¹ D. W. Breck, Zeolite Molecular Sieves, John Wiley & Sons, New York, 1976, p. 86.
² K. Schuman, B. Unger, A. Brandt; OT 2010, 82, 6, 929.
³ R. Xu, J. Chen, Z. Gao and W. Yan (eds.), Stud. Surf. Sei. Catal. 170: Proc. 15th. Intern. Zeol. Conf., Bejing 2007, Elsevier, 2007.
⁴ A. Hauer, Dissertation, TU Berlin, 2002.
⁵ A. Hauer, 23. deutsche Zeolithtagung 2.-4. März 2011, Erlangen (Book of Abstracts, Dechema, p. 36).
⁶ J. Jänchen, D. Ackermann, E. Weiler, H. Stach and W. Brösicke, Proc. Third Workshop of IEA/ECES Annex 17, 1-2 Oct. 2002, Tokyo.
⁷ S. J. Schmieg, B. K. Cho, S. H. Oh; Applied Catalysis B: Environmental, 2004, 49, 113-125.
⁸S. B. C. Pergher, R. M. Dallago, R. C. Veses, C. E. Gigola, I. M. Baibich; Journal of Molecular Catalysis A: Chemical, 2004, 209, 107-115.
⁹ H. Richter, I. Voigt, J.-T. Kuhnert, Desalination 2006, 199, 92.
¹⁰ J. T. Mullhaupt, P. C. Stephenson, U.S. Pat. No. 5,554,208, 1995.
¹¹ K. Steigleder, U.S. Pat. No. 5,190,903, 1991.
¹² H. Watanabe, T. Takewaki, M. Yamazaki, H. Kakiuchi, K. Inagaki, Kouji, A. Kosaka, N. Ho-sokawa, U.S. Pat. No. 7,527,777, 2005.
¹³ A. Pfenninger in “Molecular Sieves—Science and Technology”, vol. 2, Springer-Verlag, 1999, 163.
¹⁴ T. Takeuchi, M. Mouri, S. Okabayashi, S. Miyamura; U.S. Pat. No. 5,387,564, 1995.
¹⁵ K. Schumann, A. Brandt, B. Unger, F. Scheffler, Tagungsband zum Jahrestreffen des Fachausschusses Adsorption, 24-25 Mar. 2011, Wurzburg, 24.
16 H. Kerskes, K. Sommer, H. Müller-Steinhagen, Abschlussbericht: MonoSorp Ein integrates Konzept zur solarthermischen Gebäudeheizung mit Sorptionswärmespeicher, Förderungsnummer: BWK25006, p. 23 et seqq.
¹⁷ M. Minami, K. Enomoto; JP Patent 62 283 812 1987.
¹⁸ P. A. Howell, N. A. Acara; U.S. Pat. No. 3,119,660 1964.
¹⁹ H. Keshavan, O. P. Siclovan, D. Hancu; US Patent 2009/0318283, 2009.
²⁰ Y. Huang, A. Bar-Ilan, U.S. Pat. No. 6,759,358, 2004.
²¹ F. Scheffler, R. Herrmann, W. Schwieger, M. Scheffler, Microporous and Mesoporous Materials, 67, 2004, 53-59.
²² D. E. Hildebrandt, U.S. Pat. No. 4,381,256, 1983.
²³ A. Brandt, J. Schmeiβer, B. Unger, H. Tschritter, U. Henkel, B. Gojdär, D. Gruhle, G. Winterstein; DE Patent 10 2008 046 155, 2009.
²⁴ J. P. Verduijn; U.S. Pat. No. 5,665,325 1997.
²⁵ G. Heinze, G. Reiss, F. Schwochow, G. Ulisch; U.S. Pat. No. 3,773,690 1973.
²⁶ B. Hees, L. Puppe, G. Reiss; U.S. Pat. No. 5,962,358, 1999.
²⁷ D. Bathen, M. Breitbach, “Adsorptionstechnik”, Springer-Verlag, 2001, 13.
²⁸ T. Takeuchi, M. Mouri, S. Okabayashi, S. Miyamura; U.S. Pat. No. 5,387,564, 1995.
²⁹ H. Miyamoto, M. Ohta, K. Ishikawa, Y. Sukeda, M. Kaji, U.S. Pat. No. 5,518,678, 1995.
³⁰ H.-G. Fritz, C. Trefzger, H. H. Höfer; DE Patent 198 15 564, 1999.
³¹ S. B. Ogunwumi, P. D. Tepesch, R. R. Wusirika; US Patent 2010/0304957, 2010.

1. A Compact zeolite preform, characterized in that the preform has a zeolite content of at least 90 percent.

2. The Compact zeolite preform in accordance with claim 1, characterized in that the preform is based on one of zeolite Y zeolite X, and zeolite A.

3. The Compact zeolite preform in accordance with claim 1, characterized in that the preform is in the form of one of a plate, a tube, a solid cylinder, and a honeycomb structure.

4. A method for producing a compact zeolite preform, the method comprising:
a) processing a mouldable mixture, comprising zeolite, and a zeolite precursor component, into the preform,
b) thermally treating the preform; and
c) aging and bringing the preform into contact with a further component from which, in combination with the zeolite precursor component, zeolite can be produced and exposed to conditions under which the zeolite forms from the further component and the zeolite precursor component.

5. The method in accordance with claim 4, further comprising shaping the mouldable mixture by one of extruding, pressing and casting

6. The method in accordance with claims claim 4, characterized in that kaolin is used as the zeolite precursor component.

7. The method in accordance with claims claim 4, characterized in that the zeolite and the zeolite precursor component in step a) are in a weight ratio of 10:1 to 1:10.

8. The method in accordance with claim 4, characterized in that the thermally treating takes place at a temperature of 550° C. to 850° C.

9. The method in accordance with claim 4, characterized in that the aging and bringing follows the thermally treating.

10. The method in accordance with claim 4, characterized in that a sodium silicate solution and/or a sodium aluminate is used as the further component in step c).

11. The method in accordance with claim 4, characterized in that during the aging and bringing the further component and the zeolite precursor component are brought into contact at a temperature in the range of 75° C. to 100° C.

12. The method in accordance with claim 11, characterized in that during the aging and bringing the further component and the zeolite precursor component are brought into contact over a period of 1 to 48 hours.

13. The method in accordance with claim 11, characterized in that the bringing is carried out at temperatures between 75° C. to 100° C. and wherein the aging is carried out at a temperature of 15 to 60° C. over a period of 0.5 to 24 hours.

14. The method in accordance with claim 4, further comprising washing the preform, the further component, and the zeolite precursor component with one or more alkali hydroxide solutions and water, dried and activated up to a residual moisture content of <2 wt. %.

15. A Compact zeolite preform according to the method specified in claim 4.

16. (canceled)

17. The method of claim 4, further comprising watering the preform.

18. The Compact zeolite preforms of claim 1, wherein the preform has a zeolite content of at least 95%.

19. The method in accordance with claim 7, characterized in that the zeolite and the zeolite precursor component in step a) are in a weight ratio of 1:1 to 6:1.

20. The method in accordance with claim 8, characterized in that the thermally treating takes place at a temperature of 550 to 650° C.

21. The method in accordance with claim 11, characterized in that during the bringing the further component and the zeolite precursor component are brought into contact at a temperature in the range of 80° C. to 95° C.
